(19) United States
(12) Patent Application Publication
(10) Pub. No.: US 2003/0046132 A1
(43) Pub. Date: Mar. 6, 2003

(54) AUTOMATIC NEGOTIATION WITH VENDOR FOR UPGRADING

(76) Inventor: THOMAS M. KEELEY, BROOKFIELD, WI (US)

Correspondence Address: JOHN J HORN, ALLEN BRADLEY COMPANY INC, PATENT DEPT 704P FLOOR 8 T29, 1201 SOUTH SECOND STREET, MILWAUKEE, WI, 53204

(21) Appl. No.: 09/407,664

(22) Filed: Sep. 28, 1999

(51) Int. Cl. G06F 17/60

(52) U.S. Cl. 705/8

(57) ABSTRACT

The present invention provides a plurality of factory automated components with a unique identifier containing status information, for example, component source address information, vendor site address information, component type information, component version information and component health information. Each component will periodically send status message across a network to the supplier or vendor to an address set by the supplier or vendor or a service supplier. The receiving site will compare the component information against its database and be able to recognize whether product upgrades are available, whether maintenance should be scheduled, or that there might be a safety issue or application solution or opportunity that might be helpful to the customer.

### TECHNICAL FIELD

The present invention generally relates to a system and method for obtaining and using version data and diagnosis and failure prediction data of factory automated equipment. In particular, the present invention employs a plurality of factory automated equipment components with intelligence information about the component that can be provided to a vendor via a communication link, so that the vendor can determine if a component supplied by the vendor to a customer needs maintenance, upgrading or replacement.

### BACKGROUND OF THE INVENTION

Factory automation components are widely employed in industrial and commercial facilities. These components are relied upon to operate with minimal attention and provide for long, reliable operation. Many facilities operate several hundreds or even thousands of such components concurrently, many of which are integrated into a large interdependent process or system. Like most components, at least a small percentage of such components are prone to failure. The majority of such failures can be attributed to either mechanical failures and/or thermal failures of the components. Other than normal aging, failures are typically due to: poor or no maintenance; improper application (e.g., wrong enclosure, excessive loading, etc.); and improper installation (e.g., misalignment, bad power, inverter mismatch, etc.). Even with normal aging failures, it is desirable to provide low cost failure prediction information for such components. Depending on the application, the failure of a component in service can possibly lead to system or process down time, inconvenience, and possibly even a hazardous situation. Thus, it desirable to diagnose the components for possible failure or faults early in order to avoid such problems. Absent special monitoring for certain components problems, the problems may have an insidious effect in that although only a minor problem on the onset, the problem could become serious if not detected.

In other situations, components may be operating less efficient than would be possible if the components were upgraded with the most recent hardware and/or software relating to that specific component. Typically, customers and vendors are unaware of the specific version of the automated factory component running in a customer's factory. Therefore, these components are not upgraded or replaced until the customer is alerted by a failure or inefficiency caused by the component. Once this occurs, the customer must contact the vendor to order a new part or upgrade. This results in costly factory downtime, while the customer communicates the customer's needs are to the vendor and the vendor delivers the new component or upgrade.

Most components are purchased from vendors and implemented into the factory by customers or system integrators. The time of purchase is the last time the vendor and the purchaser communicate unless one party or the other decides it is time for another contact. From the vendor's standpoint the next call may be a normal sales call where the vendor tries to take another order. Depending on the knowledge of the customer or of the vendor on the customer's needs, that dialog may be at a very high administrative level and not yield the most efficient contact for results for either party. Also as customers of products reduce their internal support staff due to technology and/or lack of resources, the problem of the vendor not knowing the customers' needs and the customers not knowing their own needs increases.

Consequently, there is a strong need in the art for a system and/or method for providing component health and status information directly to the vendor, so that the vendor can take a proactive position with respect to customer's needs as opposed to a reactive position.

### SUMMARY OF THE INVENTION

Current technological advances have provided for implementation of intelligence into simple components that were not available in the past. Microprocessors and server systems can be built today that are not only very small (e.g. the size of a pea), but are also very inexpensive to manufacture. These microprocessors and server systems can be employed into simple factory automated components, such as limit switches, push buttons and smart sensors, in addition to more complicated components, such as motor controllers and programmable logic controllers. Many products today have built in controllers that can provide self diagnostic and version information. Web server/browsers and an Internet Protocol or IP address can be added to these controllers at littler or no additional costs allowing the components to take on a more aggressive role in communicating potential product fixes and enhancements. These product fixes and enhancements needed by the components can be communicated directly to vendors or suppliers (that provide the components to the customers) via a communication link. Due to increased availability and ease of connection to the Internet, most components can be networked through the Internet to a vendor, vendor's server and/or website, thus providing the vendor with component health status and version information.

The present invention provides a plurality of factory automated components with a unique identifier containing status information, for example, component source address information, vendor site address information, component type information, component version information and component health information. Alternatively, the status information could also include customer name information, customer site information and component location information. Each component will periodically send a status message across a network to the supplier or vendor to a target address set by the supplier or vendor or a service supplier. The receiving site will compare the component information against its database and be able to recognize whether product upgrades are available, whether maintenance should be scheduled, or that there might be a safety issue or application solution that might be helpful to the customer. For example, the present invention affords for determining whether a replacement component would improve system efficiency.

In accordance with one particular aspect of the invention, a message could be returned to the sending component, so that the action could be initiated locally (e.g., initiate a fault signal on the device). Otherwise the information could be supplied to the vendor, so that the vendor could initiate action with the customer. In another aspect of the invention, a message could be returned to the sending component that provides an automatic action initiated by the vendor, such as a product upgrade or a calibration routine initiated by transmitting a message to the component. A return message to the component may be selectively disabled or enabled at the customer's discretion to ensure product integrity or simply for security purposes.

In accordance with one particular aspect of the present invention, a factory automation system is provided that provides status information for at least one factory automation component. The system includes a factory automation component distributed by a first party where the component resides at a site location of a second party. The component periodically communicates status information to a first party, wherein the first party compiles the status information from the component and utilizes the status information to the benefit of the second party.

Another aspect of the present invention provides for an Internet business communication system. The Internet business communication system includes a website adapted to be employed by a vendor for receiving factory automation component status information over the Internet from a plurality of factory components residing at one or more customer sites. Each component has a different IP address. The website matches component information residing at the vendor's website with the IP address of the component and provides this information to the vendor.

According to another aspect of the present invention, a method is provided for providing status information to a vendor on at least one factory automation component sold by the vendor to at least one customer. The method includes the steps of locating at least one component at a site of the at least one customer, connecting the at least one component to the vendor, communicating periodically component status information from the at least one component to the server of the vendor, searching a database of the vendor for customer identification information and component location information corresponding to the status information of the at least one component and outputting the customer identification information and component status and location information to the vendor.

Still yet another aspect of the present invention provides for an Internet business communication system. The Internet business communication system includes means for matching a factory automated component location and customer identification information with status information provided by the factory automated component over the Internet. The status information includes information relating to the health of the component wherein the component is located at a site location of a customer and communicates status information to a site of a vendor.

Another aspect of the invention provides for an electronic signal adapted to be transmitted between at least one site of a customer and a site of a vendor. The electronic signal includes a periodic status message provided by a factory automation component. The status message includes health information relating to the factory automation component. The factory automation component includes its own IP address.

Another aspect of the invention provides for an electronic signal adapted to be transmitted between at least one site of a customer and a site of a vendor. The electronic signal includes an algorithm for matching a customer and a customer site location of a factory component with a factory automation component located at the site location of the customer. The algorithm matches the customer and the component site location based on an address of the component.

According to another aspect of the present invention a factory automated component is provided. The factory automated component includes a processor, a memory coupled to the processor and a network interface coupled to the processor for transmitting and receiving data with at least one remote computer system. The factory component communicates status information periodically to the at least one remote computer system.

A further aspect of the present invention provides for a system for monitoring factory automated components located at a customer's site electronically. The system includes a central server of a vendor, wherein a plurality of factory automated components are operatively coupled to the vendor server, each of the plurality of factory automated components providing status information related thereto to the vendor server. The vendor server is configured to receive the status information from the plurality of different components, and match the status information to customer identification information and component location information of each of the plurality of factory automated components with undesirable status information.

In accordance with yet another aspect of the present invention, a system for monitoring factory automated components electronically is provided. The system includes a central server adapted to receive status information from one or more factory automated components located at one or more customer sites. The central server is located at a site of a vendor, wherein the server is configured to match component status information to customer identification information and component location information of the one or more factory automated components and output this information to the vendor.

Another aspect of the present invention provides for a system for providing status information to a vendor on at least one factory automation component sold by the vendor to at least one customer, including: means locating at least one component at a site of at least one customer; means for connecting the at least one component to a network connected to a server of the vendor; means for communicating periodically component status information from the at least one component to the server of the vendor; means for searching a database located on the server of the vendor for customer identification information and component location information corresponding to the status information of the at least one component; and means for outputting the customer identification information and component status and location information to the vendor.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other advantages and novel features of the invention will become apparent from the following detailed description of the invention when considered in conjunction with the drawings.

### BRIEF DESCRIPTION OF THE DRAWINGS

FIG. 1 is a schematic illustration of a plurality of components located at a customer's site operatively coupled to a server computer system of a vendor in accordance with one aspect of the present invention;

FIG. 2 illustrates a block diagram of a central server in accordance with one aspect of the present invention;

FIG. 3 illustrates a side view of an integrated AC induction motor and limit switch in accordance with one particular aspect of the present invention;

FIG. 4a illustrates a functional schematic diagram of an integrated AC induction motor and limit switch in accordance with the present invention;

FIG. 4b illustrates a block diagram of a current transformer and signal conditioning circuit in accordance with the present invention;

FIG. 5 illustrates a table diagram of information provided in messages sent from various factory automated components in accordance with the present invention;

FIG. 6 illustrates a table diagram of outputted from a vendor's site in response to information provided in messages sent from various factory automated components in accordance with the present invention;

FIG. 7 illustrates a flow diagram of the factory automated component sending status information to the site of the vendor in accordance with the present invention; and

FIG. 8 illustrates a flow diagram of a response of the site of the vendor to the component sending status information to the site of the vendor in accordance with the present invention.

### DETAILED DESCRIPTION OF THE INVENTION

The present invention will now be described with reference to the drawings, wherein like reference numerals are used to refer to like elements throughout.

As is mentioned above, the present invention relates to a system and method for obtaining and using version and diagnostics and failure prediction data. In particular, the present invention employs intelligence in factory automated components, so that they may provide version and health information directly to vendors that sell such components via a communication link (e.g. over the Internet). As mentioned above, it is to be appreciated that the present invention can be applied to most factory automated components (e.g., limit switches, sensors, push buttons, motor controllers, PLC's, motors, pumps, generators, gear boxes, etc.) and/or systems where self diagnostics is performed for determining the version and/or state (e.g., health) of the component or system.

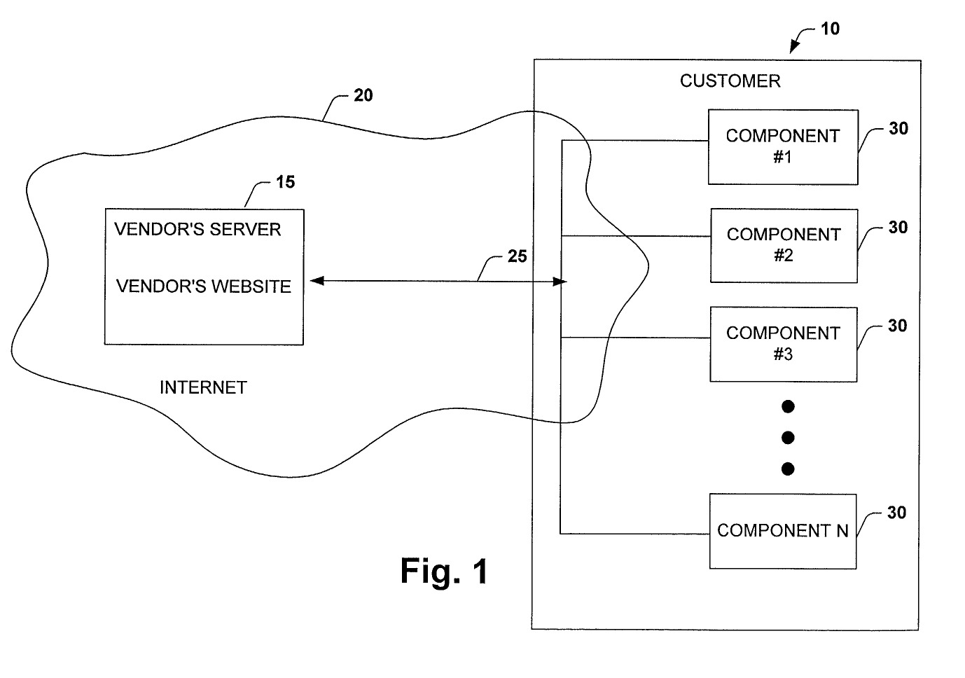

Referring initially to FIG. 1, one specific environment in which the present invention may be employed is shown. As previously stated, the present invention could take advantage of the wide availability and versatility of the Internet. Referring to FIG. 1, a schematic block diagram that depicts an environment of interest to a preferred embodiment of the present invention. A customer's factory site 10 is shown connected to a vendor's server 15 contain a vendor's web site that is part of the Internet 20. The customer's site 10 and server 15 are connected via an Internet connection 25 using a public switched phone network, for example, such as those provided by a local or regional telephone operating company. The Internet connection 25 may also be provided by dedicated data lines, Personal Communication Systems (“PCS”), microwave, or satellite networks, for example, or any suitable means. The customer's factory site 10 includes a number of different or similar components 30 directly connected to the Internet via a communication link, such that each component 30 can provide status information directly to the vendor's server 15. It is to be understood that the terms site and server are to be construed in the broadest sense, and that all such constructions of the terms are intended to fall within the scope of the hereto appended claims.

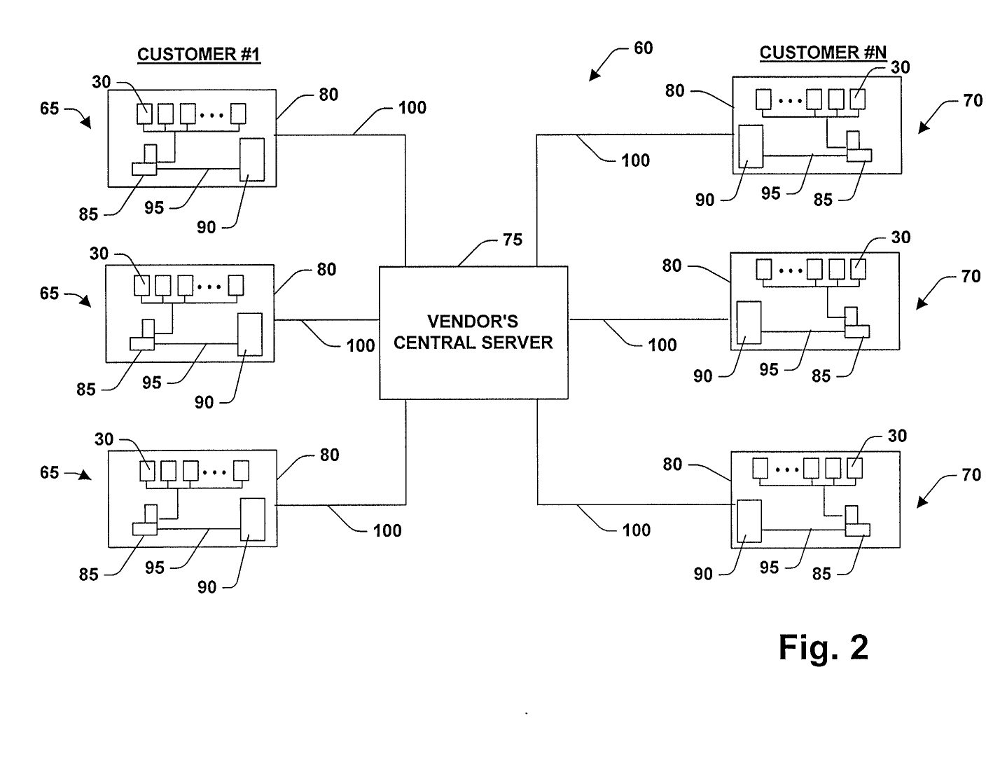

Referring to FIG. 2, another specific environment in which the present invention may be employed is shown. A first customer 65 up to an Nth customer 70 (“N” being an integer) may access a vendor's central server 75 in any of a variety of ways. For example, in the present embodiment, the customer 65 and the customer 70 could have a plurality of site locations 80 which include one or more respective computer systems 85 and local servers 90. The number of components 30 are linked to the one or more respective computers 85. The computer systems 85 compile the status information data provided by each component 30. It should be appreciated that it is preferred that the status information includes component version and health information, but the status information could also include customer identity information and site location information. The computer systems 85 may, for example, be a desktop or laptop computer with a local area network (LAN) interface for communicating the compiled version and health information over a network backbone 95 to the local server 90. The local servers 90, in turn, interface with the vendor's central server 75 via a network cable 100 or the like. It will be appreciated that while the present embodiment depicts the computer system 85 communicating with the central server 75 via hardwired network connections, in an alternative embodiment the computer system 85 may interface with the central server 75 using a modem, wireless local area and/or wide area networks, etc.

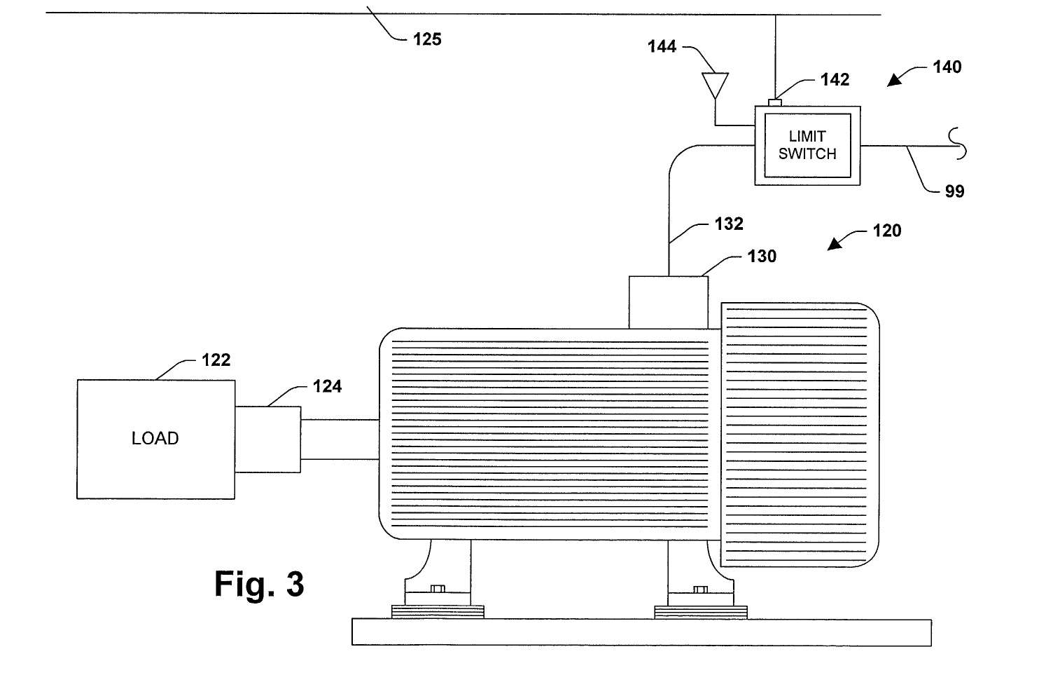

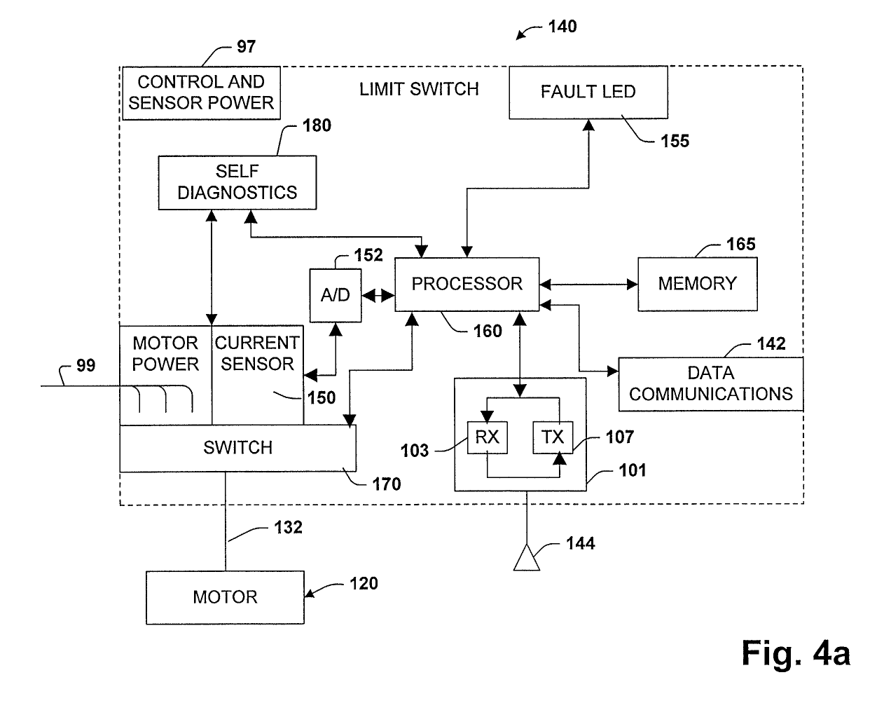

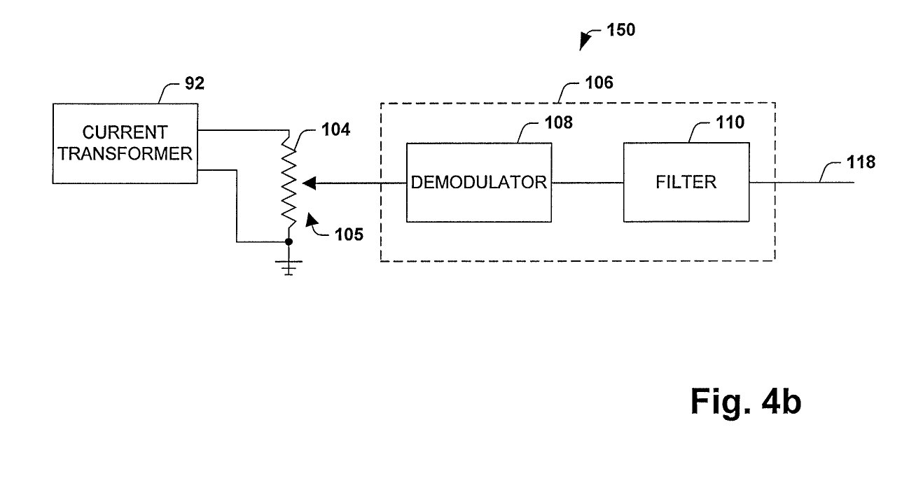

Referring now to FIG. 3, a three-phase AC induction motor 120 is depicted driving a load 122 through a shaft coupling 124. The motor 120 includes a junction box 130 for receiving conductors from power lines via a conduit 132, which is tied to a limit switch 140 adapted to limit the amount of current provided to the motor 120. The limit switch 140 is tied to power supply lines 99 (FIG. 4a) of the motor 120. The motor 120 is AC powered and operates at an AC power line frequency of 60 Hz. However, it is appreciated that different line frequencies (e.g., 50 Hz) may be employed.

The limit switch 140 includes a communications port 142 for interfacing the limit switch 140 via a conventional communications link. According to a preferred aspect of the present invention, the limit switch 140 is part of a communication system including a network backbone 125. The network backbone 125 may be a hardwired data communication path made of twisted pair cable, shielded coaxial cable or fiber optic cable, for example, or may be wireless or partially wireless in nature. Status information from the limit switch 140 is transmitted via the network backbone 125 between the limit switch 142 and a host computer (not shown) coupled to the network backbone 125 (see FIG. 2) or limit switch 140 could be connected directly to a vendor's central server and/or website via the Internet (see FIG. 1). Any communication link suitable for carrying out the present invention may be employed.

Referring now specifically to FIG. 4a, a schematic representation of the present invention is shown according to one particular aspect of the present invention, wherein the limit switch 140 is integrated with the three phase induction motor 120. However, it will be appreciated from the discussion herein that the limit switch 140 may be located remotely from the motor 120. The induction motor 120 includes the load 122 at the front end thereof. The output shaft 124 connects the load 122 to the motor 120. The load 122 may be any device or article typically driven by the motor 120 such as a pump.

At least one motor current sensor 150 is connected directly to the power lead wires 99 (shown as motor power) connecting the induction motor 120 to a source of power. Frequently the source of power is a motor control center (not shown). Motor control centers are often used with industrial-rated electric motors to start, control and protect the electric motor and associated electric circuitry. The motor control center typically contains motor starters to start and stop the motor along with circuit breakers to protect the electric motor and electric wiring. Preferably, the at least one motor current sensor 150 is arranged as a current transformer on at least one power line 99 to generate a signal corresponding to the current flowing through the respective power lead wire(s).

Turning briefly to FIG. 4b, the output of the current sensor 150 (i.e., the output of the current transformer secondary 92) is a variable current signal proportional to the time-varying current flowing in the lead wire 99, and is applied across a load resistor 104 to generate a varying voltage across the resistor 104 which is proportional to the motor current. The resistor 104 may be in the form of a potentiometer having one end grounded. The variable contact 105 of the resistor 104 is connected to the input of a signal conditioning circuit 106. The resistor 104 is adjusted to provide a selected proportional relationship between the motor current and the corresponding AC voltage signal applied to the signal conditioning circuit 106. The signal conditioning circuit 106 includes a demodulator 108, in this case an RMS-to-DC converter, a device which produces a voltage proportional to the root-mean square (RMS) value (over a preset time interval), of the motor current signal. The demodulated signal is fed through a low pass filter 110 having an upper frequency cutoff below 60 Hz to remove spectra associated with the 60 Hz line frequency and its harmonies.

As will be discussed in greater detail below and illustrated in FIG. 4a, the conditioned signal 118 is then fed to a processor 160 in the herein described manner. The processor 160 extracts current information from the conditioned signal 118 obtained from the raw motor current. The processor receives the current signal information from an A/D converter 152 and determines if the current is too high. If the current is too high, the processor 160 informs a switch 170 to cut off the current supply to the motor 120.

The processor 160 is also responsible for controlling general diagnostics of the limit switch 140. The processor communicates to a self diagnostic device 180, which performs self diagnostics on current sensor 150 and switch 170 to determine the health status of limit switch 140. The processor 160 is programmed to control and operate the various components within the limit switch 140 in order to carry out the various functions described herein. The self diagnostics device 180 can communicate fault information to the processor 160 or the vendor's central server can communicate fault information to the processor 160 based on the health status information provided it by the processor 160. The processor 160 can then enable a fault warning to the customer, such as illuminating a fault LED 155. The processor or CPU 160 can be any of a plurality of processors, such as the p24T, Pentium 50/75, Pentium 60/90, and Pentium 66/100, Pentium PRO and Pentium 2, and other similar and compatible processors. The manner in which the processor 160 can be programmed to carry out the functions relating to the present invention will be readily apparent to those having ordinary skill in the art based on the description provided herein.

A memory 165 tied to the processor 160 is also included in the limit switch 140 and serves to store program code executed by the processor 160 for carrying out operating functions of the limit switch 140 as described herein. The memory 165 also serves as a storage medium for temporarily storing information such as diagnostic analysis data, tables and the like. The memory 165 is adapted to store a complete set of the information to be communicated to the vendor's server and/or website. According to a preferred embodiment, the memory 165 has sufficient capacity to store multiple sets of information, and the processor 160 could include a program for alternating or cycling between various sets of information.

The memory 165 includes read only memory (ROM), random access memory (RAM) and flash memory. The memory contains among other code the Basic Input-Output System (BIOS) which controls the basic hardware operations of the limit switch 140. The memory contains the basic IP address of the component, the component type (e.g. limit switch), the version number and the IP target or vendor address. The memory also includes self diagnostic routines for performing self diagnostics on the limit switch 140. Furthermore, the memory will also include the health status of the limit switch 140 obtained from the diagnostic routines. Power is provided to the processor 160 and other components forming the limit switch 140 from a control and sensor power unit 97. However, it will be appreciated that such power could be obtained from the motor power leads 99 themselves via power converting circuitry (not shown).

The limit switch 140 includes a communication subsystem 142 which includes a data communication port, which is employed to interface the processor 160 with a vendor's server 15 (FIG. 1) via the internet connection 25 or with a host computer 85 (FIG. 2) via the network 125. The limit switch 140 also includes its own RF section 101 connected to the processor 160. The RF section 101 includes an RF receiver 103 which receives RF transmissions from the host computer 85 or vendor server 15 for example via an antenna 105 and demodulates the signal to obtain digital information modulated therein. The RF section 101 also includes an RF transmitter 107 for transmitting information to the network backbone 125, host computer 85 or vendor server 15 for example in response to a device failure.

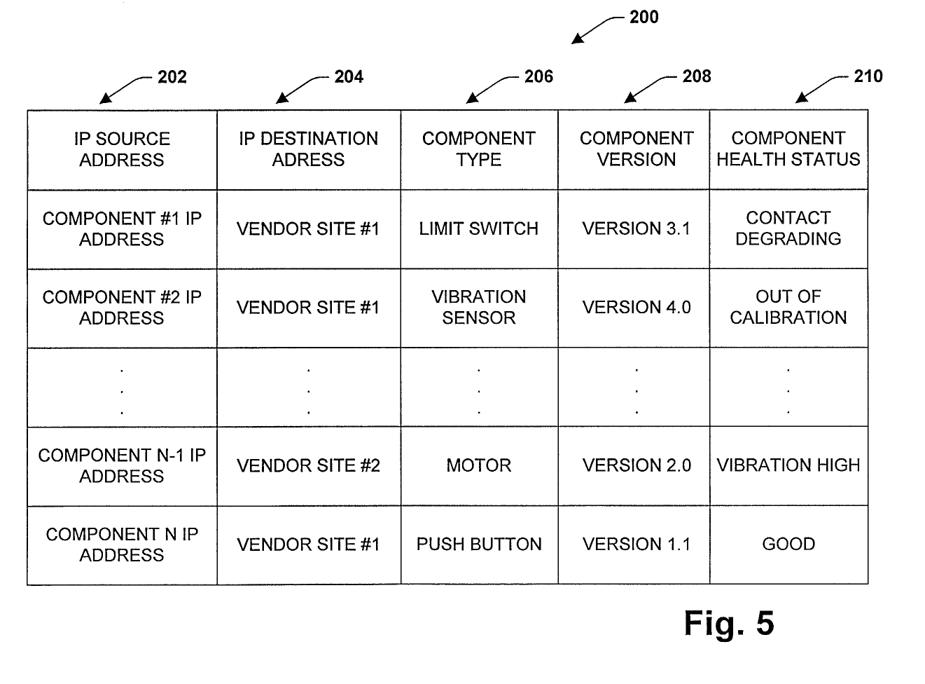

FIG. 5 illustrates an example of a table 200 of information that could be sent from a plurality of customers and received by a vendor. The information in each status message could include: an IP source address 202, an IP destination address 204; a component type 206; a component version 208; and a health status of the component 210. It should be noted in the example of FIG. 5 that the vendor has set up a different site for motors than the site for limit switches, vibration sensors and push buttons. The vendor could set up a single site for all components or any number of sites for different components. The vendor's site could contain a search engine that takes the above component status information as shown in table 200 and searches a database that looks up the IP address of the component and provides the customer identification information and component site and specific site location information. It should be noted that the customer site and specific component location information could be programmed into the component status information by the vendor or the customer.

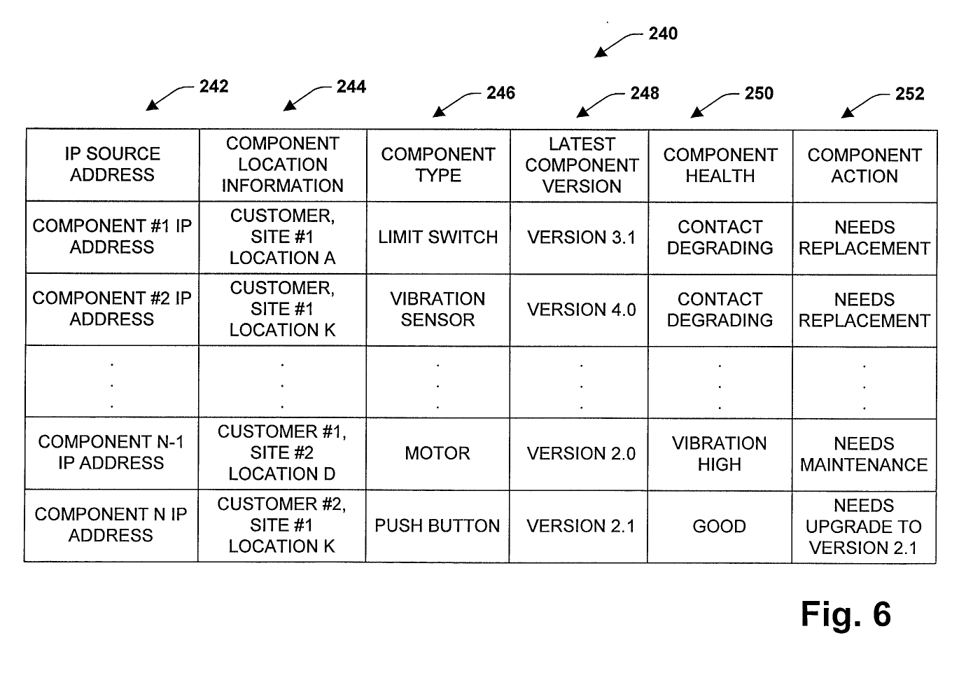

FIG. 6 illustrates a table 240 providing a typical output response produced by the search engine of the vendor in response to the information sent from the components to the vendor, as illustrated in table 200 of FIG. 5. The output response includes an IP source address for each component 242; a component location information 244; a component type 246; a latest component version 248; a component health status 250; and a suggested component action 252. As can be seen from the table 240, Component #1 is a limit switch with a degrading contact. The suggested component action is to replace the limit switch of Customer #1, at site #1, where the limit switch is specifically located at location A of site #1. Component #2 is a vibration sensor that is out of calibration. The suggested component action is to calibrate the vibration sensor of Customer #1, at site #1, where the sensor is specifically located at location K of site #1. Component #N is a push button with an outdated software version. The suggested component action is to upgrade the push button software from version 1.1 to version 2.1 for Customer #2, at site #1, where the component is specifically located at location K of site #1.

It should be appreciated that the suggested information provided by the component to the vendor from the customer's site is only a sample and any number of status information relating to the component could be communicated to the vendor. Furthermore, the number of outputs generated by the vendor utilizing the status information is only an example and any number of actions and outputs could be generated for use by the vendor.

Once the vendor has the compiled the information from the components of a particular customer at a particular location, the vendor can arrive at the customer's site with the appropriate replacement parts and/or upgrades. This eliminates inefficient communication between the vendor and their customers, while also reducing any factory downtime experienced by the customer.

It should be appreciated that many of the component actions could be performed automatically by the vendor's site. For example, the specific software revision upgrade of the pushbutton could be automatically downloaded to the push button. Furthermore, the calibration of the vibration sensor could be automatically performed by downloading a calibration routine to the sensor or invoking a calibration routine already residing on the sensor by sending a specific message or signal.

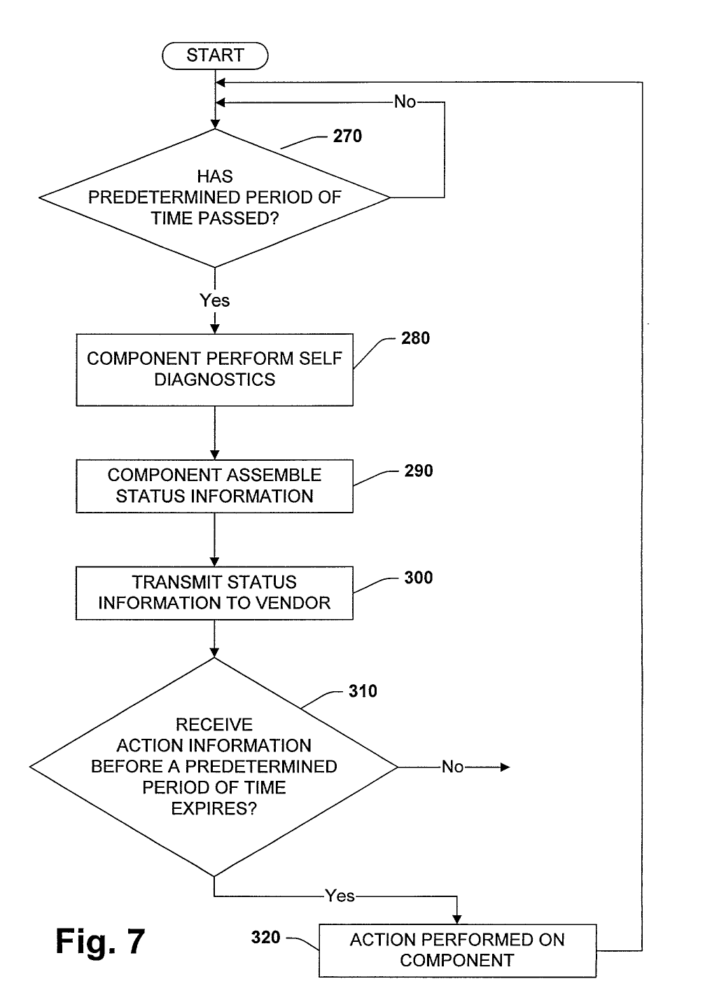

FIG. 7 illustrates the steps taken by the present invention to periodically transmit component status information to the vendor's server and/or web site. Beginning in step 270, the processor 160 of the limit switch 140 determines if a predetermined time has taken place since the limit switch 140 transmitted status information to the vendors' server 15. If a predetermined period of time has not passed, the processor repeats step 270. If a predetermined period of time has passed, the processor 160 advances to step 280 to perform self diagnostics. The processor 160 then advances to step 290 to assemble the status information of the limit switch 140, which could include component health information and/or component version information. The processor 160 then links with the vendors' server 15 and sends status information over the communication link 25. The processor 160 then waits a predetermined amount of time for automated action information to be received by the server 15. If no information is received from the server 15, the processor 160 returns to step 270. If automatic action information is received, the action is performed on the limit switch 140, in step 320.

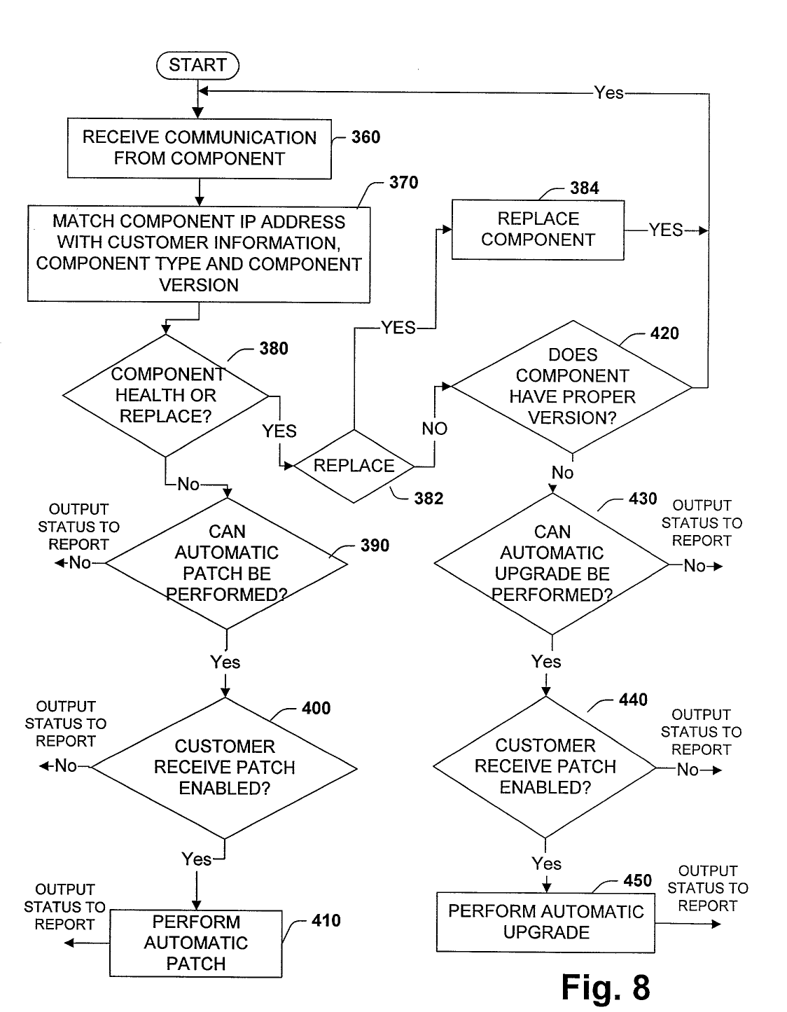

Referring now to FIG. 8 illustrating a process run by the vendor's server 15 for receiving communication from a component of a customer. In step 360, the server 15 receives a communication from a component. The server 15 then utilizes a search engine to match the IP address and/or the information within the status information from the component with the customer identification information, the component type and the component's latest version information, in step 370. In step 380, the server 15 determines whether or not the component is healthy. If the component is not healthy, the server 15 determines whether or not an automatic patch can be performed on this type of component, in step 390. If no, the server 15 outputs the status information to a report for the vendor to utilize in contacting the customer. If yes, the server 15 advances to step 400 and determines if the customer has enabled the component, so that it can receive patch information. If no, the server outputs the status information to a report for the vendor to utilize in contacting the customer. If step 400 is yes, the server 15 downloads the patch to the component, in step 410, and then outputs the status information to a report for the vendor to utilize. Returning to step 380, if the component is healthy or may need to be replaced, the server proceeds to step 382. If the component needs to be replaced the process advances to step 382 where the component is replaced and then the process returns to step 360. In step 382, if the component is healthy and does not need to be replaced the server determines if the appropriate component version is loaded on the component, in step 420. If the correct version is loaded the server 15 returns to step 360. If the correct version is not loaded, the server 15 determines whether or not an automatic upgrade can be performed on this type of component, in step 430. If no, the server outputs the status information to a report for the vendor to utilize in contacting the customer. If step 430 is yes, the server 15 determines if the customer has enabled the component, so that it can receive upgrade information, in step 440. If no, the server outputs the status information to a report for the vendor to utilize in contacting the customer. If step 440 is yes, the server 15 downloads the upgrade information to the component, in step 450, and then outputs the status information to a report for the vendor to utilize.

What has been described above are preferred embodiments of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A factory automation system for providing status information on at least one factory automation component, comprising:
a factory automation component distributed by a first party;
the component residing at a site location of a second party; and
the component periodically communicating status information to the first party wherein the first party compiles the status information from the component and utilizes the status information to the benefit of the second party.

2. The system of claim 1, wherein the first party is a vendor and/or service supplier of the component.

3. The system of claim 1, wherein the second party is a purchaser of the component and the site location is a factory of the purchaser where the component resides.

4. The system of claim 1, wherein the component communicates component health information to the first party from the location site of the second party.

5. The system of claim 4, wherein the health information is selected from the group consisting of a component failure, a component degradation and a component out of calibration.

6. The system of claim 4, wherein the site of the first party communicates patch information to the component in response to health information from the component.

7. The system of claim 1, wherein the component communicates version information to the server site of the first party from the location site of the second party.

8. The system of claim 7, wherein the server site of the first party communicates version upgrade information to the component in response to version information from the component that does not correspond to the latest version.

9. The system of claim 1, wherein the server site of the first party transmits a signal to the component in response to status information from the component that initiates an action by the component.

10. An Internet business communication system, including:
a website adapted to be employed by a vendor for receiving factory automation component status information over the Internet from a plurality of factory components residing at one or more customer sites, each component having a different IP address, the website matching component information residing at the vendor's website with the IP address of the component and providing this information to the vendor.

11. The system of claim 10, wherein the status information includes the components health information, such that the vendor can communicate to a customer that one of the plurality of components in the one or more customer sites require attention by the customer.

12. The system of claim 10, wherein the status information includes the components version information, such that the facilitator can communicate to a customer that one of the plurality of components in the one or more customer sites require a version update.

13. The system of claim 10, wherein the status information includes customer identification information, customer site information and the component location within the customer's site.

14. The system of claim 10, wherein the component information includes customer identification information, customer site information and the component location within the customer's site.

15. The system of claim 10, wherein the status information includes component health information and the website can communicate patch information to at least one of the plurality of components in response to component health information.

16. The system of claim 10, wherein the status information includes the component version information, such that the website can communicate version upgrade information to at least one of the plurality of components in response to component version information.

17. The system of claim 10, wherein the website transmits a signal to the to at least one of the plurality of components in response to status information from the component that initiates an action to the component.

18. A method of providing status information to a vendor on at least one factory automation component sold by the vendor to at least one customer, comprising the steps of:
locating at least one component at a site of at least one customer;
connecting the at least one component to a network connected to a server of the vendor;
communicating periodically component status information from the at least one component to the server of the vendor;
searching a database located on the server of the vendor for customer identification information and component location information corresponding to the status information of the at least one component; and
outputting the customer identification information and component status and location information to the vendor.

19. The method of claim 18, wherein the status information includes an IP address associated with the component and the step of searching includes matching the customer identification information and component location information corresponding to the IP address included in the status information.

20. The method of claim 18, further including the step of communicating a signal to the at least one component from the server in response to the component status information that initiates an action to the at least one component.

21. The method of claim 18, wherein the server determines if the at least one component has enabled the at least one component to receive communication from the server.

22. The method of claim 18, wherein the status information includes component health information of the at least one component.

23. The method of claim 22, wherein the server communicates patch information to the component in response to health information from the component.

24. The method of claim 18, wherein the status information includes version information of the at least one component.

25. The method of claim 24, wherein the server communicates version upgrade information to the at least one component in response to version information from the at least one component that does not correspond to the latest version.

26. An electronic signal adapted to be transmitted between at least one site of a customer and a site of a vendor, comprising:
an algorithm for matching a customer and a customer site location of a factory component with a factory automation component located at the site location of the customer, the algorithm matching the customer and the component site location based on an address of the component.

27. An electronic signal adapted to be transmitted between at least one site of a customer and a site of a vendor, comprising:
a periodic status message provided by a factory automation component, the status message including health information relating to the factory automation component, the factory automation component having an IP address.

28. The signal of claim 27, wherein the site of the vendor is a website which matches the IP address of the component with customer identification information and component location information.

29. An Internet business communication system, including:
means for matching a factory automated component location and customer identification information with status information provided by the factory automated component over the Internet, the status information including information relating to the health of the component wherein the component is located at a site location of a customer and communicates status information to a site of a vendor.

30. A factory automated component, comprising:
a processor;
a memory coupled to the processor; and
a network interface coupled to the processor for transmitting and receiving data with at least one remote computer system, wherein the factory component communicates status information periodically to the at least one remote computer system.

31. The component of claim 30, wherein the status information includes health information related to the health of the component.

32. The component of claim 30, wherein the status information includes version information related to the version of the component.

33. The component of claim 30, wherein the component includes an enabled mode for receiving communication from the at least one computer and a disabled mode blocking communication from at least one computer.

34. A system for monitoring factory automated components electronically, comprising:
a central server adapted to receive status information from one or more factory automated components located at one or more customer sites, the central server being located at a site of a vendor, wherein the server is configured to match component status information to customer identification information and component location information of the one or more factory automated components and output this information to the vendor.

35. The system of claim 34, wherein the status information includes the components version information, such that the server can communicate to a customer that one or more components require a version update.

36. The system of claim 34, wherein the server transmits a signal to the one or more components via the at least one remote computer in response to status information from the component that initiates an action to the component.

37. The system of claim 34, wherein the server hosts a website of the vendor and the server matches the component status information with the customer identification information and component location information by using an IP address associated with the component.

38. The system of claim 35, wherein the status information includes the components health information, such that the vendor can communicate to a customer that the one or more components in the one or more customer sites require attention by the customer.

39. A system for providing status information to a vendor on at least one factory automation component sold by the vendor to at least one customer, comprising:
means locating at least one component at a site of at least one customer;
means for connecting the at least one component to a network connected to a server of the vendor;
means for communicating periodically component status information from the at least one component to the server of the vendor;
means for searching a database located on the server of the vendor for customer identification information and component location information corresponding to the status information of the at least one component; and
means for outputting the customer identification information and component status and location information to the vendor.
